(19) United States
(12) Patent Application Publication
(10) Pub. No.: US 2026/0077415 A1
(43) Pub. Date: Mar. 19, 2026

(54) ARC-SHAPED OSCILLATING SAW BLADE WITH SPARSE AND DENSE TEETH AND OSCILLATING SAW

(71) Applicant: HANGZHOU EASY CAN TOOLS CO., LTD., Hangzhou (CN)

(72) Inventors: Yifan WANG, Hangzhou (CN); Yunfeng Wang, Hangzhou (CN); Yingjie Cai, Hangzhou (CN)

(73) Assignee: HANGZHOU EASY CAN TOOLS CO., LTD., Hangzhou (CN)

(21) Appl. No.: 18/925,939

(22) Filed: Oct. 24, 2024

(30) Foreign Application Priority Data
Sep. 19, 2024 (CN) 202422289383.0

(51) Int. Cl. B23D 61/00; B23D 61/02; B23D 61/08

(52) U.S. Cl. CPC B23D 61/006; B23D 61/0212; B23D 61/08

(57) ABSTRACT

An arc-shaped oscillating saw blade with sparse and dense teeth and an oscillating saw are provided. The arc-shaped oscillating saw blade with sparse and dense teeth includes a cutting end composed of a plurality of sawteeth distributed in an arc shape, and a tooth spacing between adjacent sawteeth gradually increases from a middle position to positions at two sides of the cutting end, thus forming a sawtooth arrangement structure with dense sawteeth at a middle and sparse sawteeth at two sides. With a tooth structure with arrangement of proper tooth density gradient, a contact area between the saw blade and a material in the cutting process can be reduced, so that cutting resistance can be reduced. Arc-shaped tooth distribution facilitates improving of the cutting accuracy and surface smoothness, reduces cutting errors and surface defects, reduces impact and vibration in the cutting process, and further improves the cutting accuracy.

### CROSS-REFERENCE TO RELATED APPLICATION

This Non-provisional application claims priority under 35 U.S.C. § 119(a) on Chinese Patent Application No(s). 202422289383.0 filed on Sep. 19, 2024, the entire contents of which are hereby incorporated by reference.

### TECHNICAL FIELD

The disclosure relates to the technical field of oscillating saw blades, in particular to an arc-shaped oscillating saw blade with sparse and dense teeth and an oscillating saw.

### BACKGROUND ART

A cutting end of a traditional oscillating saw blade, that is, its sawtooth part, is generally linear in shape, with a uniform tooth spacing, and there is no angle change between a tip and a center of a tooth. When this type of oscillating saw blade cuts different materials, a movement direction of the saw blade is parallel to a sawtooth direction, and a shape and arrangement of the sawtooth are single in type, and the tooth of the saw blade is subjected to large resistance in a cutting process, which results in poor chip removal and heat dissipation ability of the saw blade and a rough cutting surface, which affects cutting effect, reduces cutting efficiency and adversely affects service life of the saw blade.

Dense and sparse arrangement of teeth has significant impact on cutting efficiency. The dense arrangement of teeth (that is, with more teeth) can provide a smoother cutting surface, but may slow down a cutting speed. The sparse arrangement of teeth (that is, with fewer teeth) can improve the cutting speed, but may affect smoothness of the cutting surface. Therefore, it is the key to optimize the cutting effect to choose an appropriate arrangement of teeth according to specific cutting requirements.

### SUMMARY

An object of this disclosure is to provide an arc-shaped oscillating saw blade with sparse and dense teeth and a oscillating saw, which can optimize a structure of a saw blade to improve cutting efficiency, cutting effect and service life of products.

In order to solve above problems, the disclosure provides an arc-shaped oscillating saw blade with sparse and dense teeth, which includes a cutting edge composed of a plurality of sawteeth distributed in an arc shape, and a tooth spacing between adjacent sawteeth gradually increases from a middle position to positions at two sides of the cutting end, thus forming a sawtooth arrangement structure with dense sawteeth at a middle and sparse sawteeth at two sides.

The middle position is determined by a horizontal line in a direction from a rotation central point of the saw blade to the cutting end.

Alternatively, the tooth spacing changes uniformly or non-uniformly. When the tooth spacing changes uniformly, an increased value of the tooth spacing for each time is the same, and when the tooth spacing changes non-uniformly, the increased value of the tooth spacing for each time is different.

Alternatively, the tooth spacing can be set to change the sequentially between adjacent tooth spacings, or to change in a step manner, and the step manner is preferred. Specifically, a plurality of sawtooth units are sequentially arranged from the middle position to the positions of the two sides of the cutting end, each sawtooth unit includes a plurality of sawteeth, and tooth spacings in an individual sawtooth unit are the same.

A number of sawteeth in the sawtooth unit ranges from 1 to 10.

Optionally, the tooth spacing is increased by 0.01 to 0.8 mm at a time.

Preferably, the tooth spacing is increased by 0.05 mm at a time.

According to an embodiment of the disclosure, from the middle position to the positions at the two sides of the cutting end, angles of connecting lines between tips of sawtooth away from the middle position of the cutting end and an oscillating central end of the saw blade in respective sawtooth units increase in sequence, with a sequentially increased increment.

According to an embodiment of the disclosure, the angles of the connecting lines ranges from 0.1 to 0.5.

According to an embodiment of the disclosure, a height of the sawtooth gradually increases from the middle position to the positions at the two sides of the cutting end.

An oscillating saw includes the arc-shaped oscillating saw blade with sparse and dense teeth described above.

The disclosure has beneficial effects that with a tooth structure with arrangement of proper tooth density gradient, a contact area between the saw blade and a material in the cutting process can be reduced, so that cutting resistance can be reduced, the cutting speed can be further improved, and abrasion of the saw blade can be reduced; and meanwhile, with an arrangement mode with variable tooth density, in combination with advantages of dense tooth arrangement and sparse tooth arrangement, the cutting speed can be improved and influence on smoothness of the cutting surface can be reduced. The arrangement of tooth density gradient also facilitates improving of heat dissipation and lubrication conditions of the saw blade in the cutting process. By increasing a contact area between the saw blade and cooling liquid, heat dissipation is improved, and wear caused by high temperature is reduced, thus improving service life.

Arc-shaped tooth distribution also facilitates improving of the cutting accuracy and surface smoothness, reduces cutting errors and surface defects, reduces impact and vibration in the cutting process, and further improves the cutting accuracy.

### BRIEF DESCRIPTION OF THE DRAWINGS

The disclosure will be further described with reference to the drawings and embodiments.

FIG. 1 is a front view of an arc-shaped oscillating saw blade with sparse and dense teeth;

FIG. 2 is a bottom view of an arc-shaped oscillating saw blade with sparse and dense teeth;

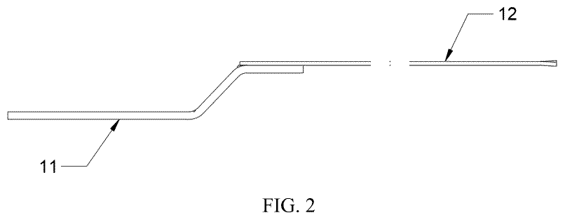

FIG. 3 is a partially enlarged schematic view of a cutting part.

### DETAILED DESCRIPTION

The following description is only intended to disclose the present disclosure so as to enable those skilled in the art to implement the disclosure. The embodiments in the following description are by way of example only, and other obvious variations will occur to those skilled in the art. The basic principle of the disclosure defined in the following description can be applied to other implementations, modified, improved and equivalent schemes and other schemes without departing from the spirit and scope of the disclosure.

### Embodiment 1

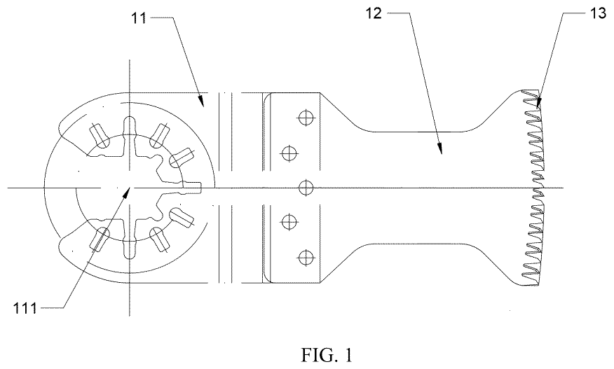

An arc-shaped oscillating saw blade with sparse and dense teeth, as shown in FIG. 1, includes a connecting part 11 and a cutting part 12. The connecting part 11 (also called a cutter pad) is configured for connecting with an oscillating saw to realize installation of the saw blade. A structural design of a connecting position is adaptively designed according to an interface of the oscillating saw, and the connecting position forms a rotation central point 111. An end of the cutting part 12 (also called the saw blade) forms a cutting end 13 (also called as a tooth part) composed of a plurality of sawteeth distributed in an arc shape, and a tooth spacing between adjacent sawteeth gradually increases from a middle position to positions at two sides of the cutting end 13, thus forming a sawtooth arrangement structure with dense sawteeth at a middle and sparse sawteeth at two sides.

The connecting part 11 and the cutting part 12 are in an integrated or split type, and when the split type is adopted, the connecting part and the cutting part are connected with each other through a connector, such as a bolt, welding or the like.

By optimizing density arrangement of teeth, the cutting effect and the cutting speed can be significantly improved, thus reducing wear of the saw blade and improving service life of products. Operation principle of this optimization mainly involves following aspects.

1. Cutting resistance is reduced:
with a tooth structure with arrangement of proper tooth density gradient, a contact area between the saw blade and a material in the cutting process can be reduced, so that the cutting resistance can be reduced. This effect of reducing the cutting resistance facilitates improving of a cutting speed and reduces wear of the saw blade.

2. Cutting efficiency is improved:
With an arrangement mode with variable tooth density, in combination with advantages of dense tooth arrangement and sparse tooth arrangement, the cutting speed can be improved and influence on smoothness of the cutting surface can be reduced.

3. Heat dissipation is optimized:
the arrangement of tooth density gradient also facilitates improving of heat dissipation and lubrication conditions of the saw blade in the cutting process. By increasing a contact area between the saw blade and cooling liquid, heat dissipation is improved, and wear caused by high temperature is reduced, thus improving service life.

4. Cutting accuracy and surface smoothness are optimized:
Design of tooth angles, namely, arc-shaped tooth distribution, also facilitates improving of the cutting accuracy and surface smoothness, reduces cutting errors and surface defects, reduces impact and vibration in the cutting process, and further improves the cutting accuracy. For example, in a process of cutting wood, burrs can be effectively reduced and the smoothness and finish of the cutting surface can be increased.

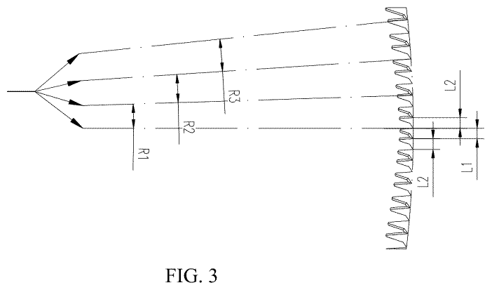

Specifically, in this scheme, the tooth spacing changes uniformly and an increased value of the tooth spacing for each time is the same, as shown in FIG. 3, L1 indicates a tooth spacing of middle teeth, which is 1.5 mm, from which the tooth spacing gradually increases to both sides, and optionally a tooth spacing of every two adjacent teeth increases in sequence, with a increment of 0.05 mm, and L2 is 1.55 mm.

Embodiment 2, it is different from Embodiment 1 in that it also can be provided that the tooth spacings of respective sawtooth units increase in sequence. In this embodiment, the sawtooth unit includes three teeth, tooth spacings in a single sawtooth unit is the same, and tooth spacings of adjacent sawtooth units differ by 0.05 mm.

In Embodiment 3, on a basis of Embodiment 1 or 2, the arc-shaped tooth structure is shown in FIG. 3. From a middle position to positions at two sides of the cutting end 13, angles of connecting lines between tips of sawtooth away from the middle position of the cutting end 13 and an oscillating central end of the saw blade (a central point 111) in respective sawtooth units increase in sequence, with a sequentially increased increment. Taking a sawtooth unit with three teeth as an example, angles of connecting lines between outer teeth in different units and the central point 111 of the saw blade are sequentially R1 of 1.79°, R2 of 1.96° (increased by 0.17°) and R3 of 2.14° (increased by 0.18°), and this angle may also change according to a cutting length of the saw blade.

Embodiment 4, on a basis of any of above embodiments, a height of the sawtooth gradually increases from the middle position to the positions at the two sides of the cutting end 13.

An oscillating saw on which the arc-shaped oscillating saw blade with sparse and dense teeth in any of above embodiments is mounted is provided.

It is should be appreciated by those skilled in the art that the above description and the embodiments of the disclosure shown in the drawings are only by way of example and do not limit the disclosure. The object of the disclosure has been completely and effectively achieved. The function and structural principle of the disclosure have been shown and explained in the embodiments; any variation and modification can be made to the embodiments of the disclosure without departing from the principle.

What is claimed is:

1. An arc-shaped oscillating saw blade with sparse and dense teeth, comprising a cutting end composed of a plurality of sawteeth distributed in an arc shape, and a tooth spacing between adjacent sawteeth gradually increases from a middle position to positions at two sides of the cutting end, thus forming a sawtooth arrangement structure with dense sawteeth at a middle and sparse sawteeth at two sides.

2. The arc-shaped oscillating saw blade with sparse and dense teeth according to claim 1, wherein the tooth spacing changes uniformly or non-uniformly.

3. The arc-shaped oscillating saw blade with sparse and dense teeth according to claim 1, wherein a plurality of sawtooth units is sequentially arranged from the middle position to the positions of the two sides of the cutting end, each sawtooth unit comprises a plurality of sawteeth, and tooth spacings in an individual sawtooth unit are the same.

4. The arc-shaped oscillating saw blade with sparse and dense teeth according to claim 3, wherein a number of the sawteeth in the sawtooth unit ranges from 1 to 10.

5. The arc-shaped oscillating saw blade with sparse and dense teeth according to claim 1, wherein the tooth spacing is increased by 0.01 to 0.8 mm at a time.

6. The arc-shaped oscillating saw blade with sparse and dense teeth according to claim 4, wherein from the middle position to the positions at the two sides of the cutting end, angles of connecting lines between tips of sawtooth away from the middle position of the cutting end and an oscillating central end of the saw blade in respective sawtooth units increases in sequence, with a sequentially increased increment.

7. The arc-shaped oscillating saw blade with sparse and dense teeth according to claim 6, wherein the angles of the connecting lines ranges from 0.1 to 0.5.

8. The arc-shaped oscillating saw blade with sparse and dense teeth according to claim 7, wherein a height of the sawtooth gradually increases from the middle position to the positions at the two sides of the cutting end.

9. An oscillating saw, comprising an arc-shaped oscillating saw blade with sparse and dense teeth, the arc-shaped oscillating saw blade with sparse and dense teeth comprising a cutting end composed of a plurality of sawteeth distributed in an arc shape, and a tooth spacing between adjacent sawteeth gradually increases from a middle position to positions at two sides of the cutting end, thus forming a sawtooth arrangement structure with dense sawteeth at a middle and sparse sawteeth at two sides.
